(19) United States
(12) Patent Application Publication
(10) Pub. No.: US 2025/0121341 A1
(43) Pub. Date: Apr. 17, 2025

(54) FIXED-BED TUBULAR REACTOR WITH OFFSET COLLECTION AND DISTRIBUTION OPENINGS

(71) Applicant: COMMISSARIAT A L'ENERGIE ATOMIQUE ET AUX ENERGIES ALTERNATIVES, Paris (FR)

(72) Inventor: Albin CHAISE, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/702,002

(22) PCT Filed: Oct. 6, 2022
(86) PCT No.: PCT/FR2022/051888

§ 371 Date: Apr. 17, 2024

(30) Foreign Application Priority Data
Oct. 19, 2021 (FR) FR2111098

(51) Int. Cl. B01J 8/02; B01J 8/06

(52) U.S. Cl. CPC B01J 8/0214; B01J 8/065; B01J 2208/00938

(57) ABSTRACT

A tubular reactor includes a bed of catalyst powder confined within an annular space, a hollow insert having a distribution chamber and a collection chamber, and a second wall having at least one distribution opening and at least one collection opening. The second wall of the hollow insert includes, on at least a first longitudinal portion of the insert defined along the longitudinal axis, at least one offset distribution opening and at least one offset collection opening, every offset distribution opening being contained in a plane transverse to the longitudinal axis different from any plane transverse to the longitudinal axis containing an offset collection opening so that the direction of flow of gas distributed and/or admitted between an offset collection opening and an offset distribution opening has an axial component.

### TECHNICAL FIELD

The present invention is directed to the field of exchanger reactor. In particular, the present invention relates to the field of catalyst exchanger reactor implementing a solid catalyst, and in particular a solid catalyst in powder form.

In this respect, the present invention provides a catalyst reactor-exchanger capable of implementing exothermic organic synthesis processes. In particular, these organic compounds may comprise synthetic fuels and a combustible.

### PRIOR ART

Catalyst reactors using solid catalysts are widely implemented for the synthesis of organic compounds such as synthetic fuels or combustibles, among which mention may be made of natural gas substitutes, dimethyl ether or methanol.

In particular, these compounds are obtained by reaction of hydrogen and carbon monoxide in the presence of a suitable solid catalyst.

However, chemical reactions related to the synthesis of these compounds are highly exothermic, and consequently release a quantity of heat likely to degrade the solid catalyst. This degradation results in a reduction in the conversion rate of the chemical species present, and a decrease in the selectivity of the reactions involved. Furthermore, the solid catalyst is deactivated under the effect of heat.

Thus, in practice, these reactions can be carried out in a shell and tube type exchanger reactor comprising a reactive channel provided with solid catalyst and continuously cooled by a heat transfer fluid. In this reactor type, the reactive gases axially circulate in the tubes which contain a catalyst, for example in powder form.

Nevertheless, despite the implementation of coolant cooling, this type of reactor remains sensitive to heat released by the reactions taking place in the reactor.

In particular, a hot spot, generally observed proximate to the reactive gas inlet, degrades the solid catalyst, and therefore reduces performance of the exchanger reactor.

In order to limit these effects, the following solutions have been provided:
a reduction in the volume density of the catalyst, in particular by depositing the same onto the walls of the tube or an insert, or by diluting it in a non-reactive medium;
a dilution of the reactive gases with part of the products generated to decrease reaction activity;
making several points for injecting one or more reagents to distribute the hot-spot zone over a larger area;
a reduction in tube dimensions, or by fitting heat-conducting parts in order to improve tube cooling.

These solutions are however not satisfactory.

Indeed, while they can help reduce effects of the hot spot, they are complex to implement.

Furthermore, their implementation reduces flexibility of use of the exchanger reactor, and makes it less compact.

In order to overcome these problems, an arrangement has thus been provided for spreading distribution of the reagents over the entire length of the tubes. This solution thereby allows better temperature homogeneity to be obtained over the entire length of the reactor.

In this respect, documents U.S. Pat. Nos. 3,758,279 A, 4,374,094 A, EP 0 560 157 A1 and U.S. Pat. No. 2,997,374 A provide exchanger reactors implementing reagent distribution from an annular distribution space. In particular, these reactor-exchangers, with a generally cylindrical shape, comprise, arranged coaxially and starting from the outside of the reactor, a tube, the annular distribution space, a catalyst load and a collection space.

Nonetheless, this arrangement is not satisfactory.

Indeed, the presence of the annular distribution space around the catalyst load limits heat transfer from the catalyst to the tube, making the cooling systems generally implemented less effective. Nevertheless, it remains possible to insert heat-conducting elements in the reactor. Nonetheless, such a solution remains incompatible with reactors comprising tubes with a small diameter.

Conversely, document CN 103990420 A provides an insert provided with a distribution chamber and a collection chamber, arranged in the centre of a tube and defining with the same an annular space housing the solid catalyst.

Nonetheless, the arrangement provided in that document does not enable homogeneous distribution within the annular space. More particularly, this arrangement does not allow an optimum temperature profile to be obtained within the solid catalyst.

Furthermore, a principle of staged gas distribution in a exchanger reactor is known from the applicant's European patent application EP 3 827 895 A1. The reactor includes a catalyst provided in an annular space between a hollow tube and a hollow insert provided with distribution and collection chambers. Distribution and collection openings are provided for gas distribution and collection. Making such openings is not optimal, and there is still a need to design an alternative principle for making them.

One purpose of the present invention is to provide a fixed-bed tubular reactor enabling a more uniform distribution of the reagents within the solid catalyst.

Another purpose of the present invention is also to provide a fixed-bed tubular reactor enabling a more homogeneous distribution of the heat flow generated within the solid catalyst.

Another purpose of the present invention is also to provide a tubular reactor enabling better cooling management.

Another purpose of the present invention is also to provide a tubular reactor for which the reliability and the service life are improved compared to the reactors known from the state of the art.

Another purpose of the present invention is also to provide a tubular reactor allowing optimising (increasing) passage time of the gases in the fixed bed of catalyst powder.

### DISCLOSURE OF THE INVENTION

The invention aims to at least partially remedy the aforementioned needs and purposes and the drawbacks relating to the embodiments of prior art.

Thus, the object of the invention, according to one of its aspects, is a fixed-bed tubular reactor which extends, along a longitudinal axis, between a first end and a second end, the reactor comprising a bed of catalyst powder confined in an annular space delimited by a first wall of a hollow tube and a second wall of a hollow insert, arranged in and coaxial with the hollow tube, the hollow insert comprising at least one distribution chamber and at least one collection chamber, separated from each other by a partition wall, and comprising, a gas admission opening at the first end and a gas discharge opening at the second end, respectively, the second wall comprising at least one distribution opening and at least one collection opening, the distribution opening allowing distribution of a gas likely to be admitted through the admission opening of the distribution chamber into the annular space, and the collection opening allowing collection of the gas distributed into the annular space by the collection chamber, characterised in that the second wall of the hollow insert includes, on at least a first longitudinal portion of the insert defined along the longitudinal axis, at least one offset distribution opening and at least one offset collection opening, any offset distribution opening being contained in a plane transverse to the longitudinal axis different from any plane transverse to the longitudinal axis containing an offset collection opening so that the direction of the flow of gas distributed and/or admitted between an offset collection opening and an offset distribution opening has an axial component along the longitudinal axis.

The reactor according to the invention may also include one or several of the following characteristics in isolation or according to any possible technical combinations.

It is understood that insofar as the reactor according to the present invention is tubular, the hollow tube and the hollow insert are necessarily cylindrical in shape, but not necessarily cylindrical of revolution.

In addition, as long as the hollow insert is arranged in the hollow tube and coaxial with it, the annular space can have symmetry of revolution.

Thus, the reactor according to the present invention enables the reactive gases to be distributed relatively homogeneously in the annular space, due to the extent of the distribution opening. These then react with the bed of catalyst powder over the entire cross-section covered by the distribution opening. The products resulting from the reaction of the gases, as well as unreacted gases, are collected at the collection opening and discharged from the reactor through the discharge opening opposite to the admission opening.

This arrangement, in which the gases are admitted at one end and discharged at the other, allows better distribution of the reactive species (the gases) in the annular space, and consequently better distribution of heat likely to be released during the reaction of the reactive species in the annular space.

This better distribution of released heat means that a less powerful and therefore smaller cooling system can be considered.

The arrangement according to the present invention therefore makes it possible to contemplate a more compact reactor, with improved reliability compared with tubular reactors known from the state of the art.

The at least one distribution chamber can be sealed at the second end, and the at least one collection chamber can be sealed at the first end.

The reactor may comprise at the first end and at the second end, respectively, a distribution space and a collection space between which the insert is disposed.

The catalyst powder can be retained in the annular space by a seal of fibrous material at each end of the annular space.

The seal of fibrous material can be compressively held against the catalyst powder by a spring, the spring being in abutment against a holding plate mechanically connected to the tube.

The seal of fibrous material in combination with the spring(s) helps to compact the catalyst powder and prevent attrition thereof during handling or transport of the reactor.

The outer wall may be free of openings over a first cross-section and a second cross-section which extend from the first end and the second end respectively, the first cross-section and the second cross-section overlapping the bed of powder over a height H, the height H being between 0.5 times and 10 times, advantageously between 1 times and 2 times, the distance separating a distribution opening from an immediately adjacent collection opening, and measured along the outer surface of the outer wall.

Thus, such an arrangement makes it possible to impose a passage time on reactive gases likely to enter the annular space through the fibrous seal.

The hollow insert can be provided with centring means holding it in a coaxial position with the hollow tube, advantageously the centring means comprise bosses formed on the second wall.

These centring means allow easier assembly of the reactor.

The surface area of a cross-section of the distribution chamber along a sectional plane transverse to the longitudinal axis may decrease from the first end to the second end, advantageously, said surface area is zero at the second end.

Additive manufacturing methods, and in particular 3D manufacturing techniques, make it possible to produce these complex structures in the form of a one-piece part.

The surface area of a cross-section of the collection chamber along a sectional plane transverse to the longitudinal axis may increase from the first end to the second end, advantageously said surface area is zero at the first end.

The collection opening and the distribution opening can have a width of between 1/100 and ½, advantageously between 1/20 and ¼, of the diameter of the hollow tube.

The collection opening and the distribution opening can each comprise a filter preventing passage of catalyst powder into either of the collection or distribution chambers.

The filter can comprise a plurality of tilted fibre planes.

The hollow insert can form a one-piece part.

Furthermore, the second wall of the hollow insert can include, on at least one second longitudinal portion of the insert defined along the longitudinal axis, at least one aligned distribution opening and at least one aligned collection opening, any aligned distribution opening being contained in a plane transverse to the longitudinal axis also containing at least one collection opening aligned so that the direction of flow of gas distributed and/or admitted between an aligned collection opening and an aligned distribution opening has a substantially zero axial component along the longitudinal axis.

A plurality of aligned collection openings and/or a plurality of aligned distribution openings can be axially aligned along the longitudinal axis.

In addition, said at least one collection opening and/or said at least one distribution opening may be selected from among: a longitudinal slot extending over a length along the longitudinal axis; a transverse slot extending over a width transversely to the longitudinal axis; a local port, in particular of circular, oval, oblong or rectangular shape; among others.

A plurality of offset collection openings and/or a plurality of offset distribution openings may be respectively in the form of a cloud of offset collection openings, especially at least two of which are contained in a same transverse plane, and/or in the form of a cloud of offset distribution openings, especially at least two of which are contained in a same transverse plane.

The cloud of offset distribution openings can include at least one offset distribution opening dedicated to a primary gas distribution and at least one offset distribution opening dedicated to a secondary gas distribution, different from the primary gas distribution. In addition or alternatively, the cloud of offset collection openings can include at least one offset collection opening dedicated to a primary gas collection and at least one offset collection opening dedicated to a secondary gas collection, different from the primary gas collection.

Said at least one offset collection opening and said at least one offset distribution opening may not be axially superimposed along the longitudinal axis.

In addition, the minimum distance between an offset collection opening and an offset distribution opening can be between half the diameter of the insert and half the total length of the insert.

Several offset distribution openings can be located in a same transverse plane to the longitudinal axis and evenly spaced from each other. In addition or alternatively, several offset collection openings can be located in a same transverse plane to the longitudinal axis and evenly spaced from each other.

Furthermore, said at least one offset collection opening and/or said at least one offset distribution opening can be obtained by machining and/or additive manufacturing.

### BRIEF DESCRIPTION OF THE DRAWINGS

The invention may be better understood upon reading the following detailed description of non-limiting examples of implementation thereof, as well as upon examining the schematic and partial figures, of the appended drawing, wherein:

FIG. 1 is a schematic representation of a fixed-bed tubular reactor according to a first alternative of the present invention, in particular FIG. 1 represents the reactor in a longitudinal cross-sectional plane passing through a longitudinal axis XX′ of the reactor;

FIG. 2 is a schematic representation of the reactor of FIG. 1 along a cross-sectional plane perpendicular to the longitudinal axis;

FIG. 3 is a representation of a filter, especially one formed by four fibre planes, likely to be implemented in the tubular reactor according to the present invention;

FIG. 4 is a representation of a fixed-bed tubular reactor according to the first alternative of the present invention at the first end illustrating the arrangement of the seal and the spring retaining the bed of catalyst powder;

FIG. 5 is a schematic representation of the hollow insert along the sectional plane AA′ of FIG. 4;

FIG. 6 is a schematic representation of an insert according to a second alternative of the present invention, in particular FIG. 6 represents the reactor along a longitudinal sectional plane passing through a longitudinal axis XX′ of the reactor;

FIG. 7A, FIG. 7B, FIG. 7C, FIG. 7D and FIG. 7E are views, respectively, along sectional planes A, B, C, D and E of the hollow insert represented in FIG. 6;

FIG. 8 is a schematic representation of an insert according to a third alternative of the present invention, in particular FIG. 8 represents the reactor in a longitudinal sectional plane passing through a longitudinal axis XX′ of the reactor;

FIG. 9 and FIG. 10 are views, respectively, along sectional planes CC′ and DD′ of the hollow insert represented in FIG. 8;

FIG. 11, FIG. 12 and FIG. 13 are schematic representations of alternative embodiments of a second longitudinal portion of an insert comprising at least one aligned distribution opening and at least one aligned collection opening;

FIG. 14, FIG. 15 and FIG. 16 are schematic representations of alternative embodiments of a first longitudinal portion of an insert comprising at least one offset distribution opening and at least one offset collection opening;

FIG. 17 is a schematic representation of a fixed-bed tubular reactor along a longitudinal sectional plane illustrating the circulation of gas at the offset distribution and collection openings;

FIG. 18 is a schematic representation of the insert of FIG. 17; and

FIG. 19 is a cross-section view along C-C of FIG. 18.

In all of these figures, identical references may designate identical or similar elements.

Moreover, the different parts represented in the figures are not necessarily drawn to a uniform scale in order to make the figures more legible.

### DETAILED DISCLOSURE OF PARTICULAR EMBODIMENTS

The present invention relates to a tubular reactor-exchanger with a fixed bed of catalyst powder. In particular, the bed of catalyst powder is confined in an annular space delimited by a first wall of a hollow tube and a second wall of a hollow insert disposed in and coaxially with the tube.

The hollow insert according to the present invention is especially designed to allow admission of reactive gases from a first end of the reactor into a distribution chamber of the insert. These are then distributed over a cross-section of the annular space via a distribution opening allowing passage of the gases from the distribution chamber into the annular space.

Products resulting from the reaction between reactive species are then collected, via a collection opening, in a collection chamber of the hollow insert, isolated from the distribution chamber by a partition wall.

The discharge of the products is done through a discharge opening of the collection chamber at the second end.

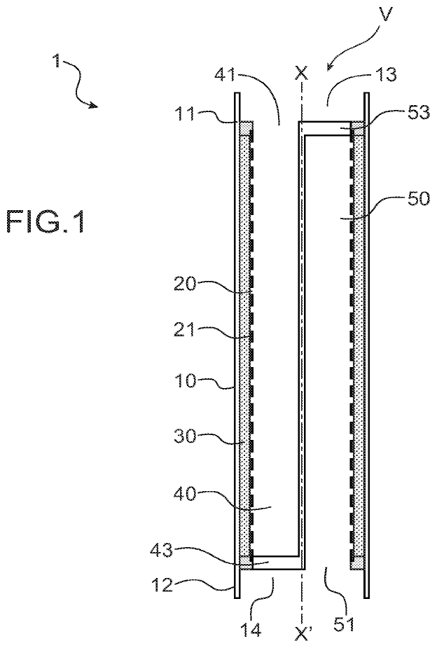

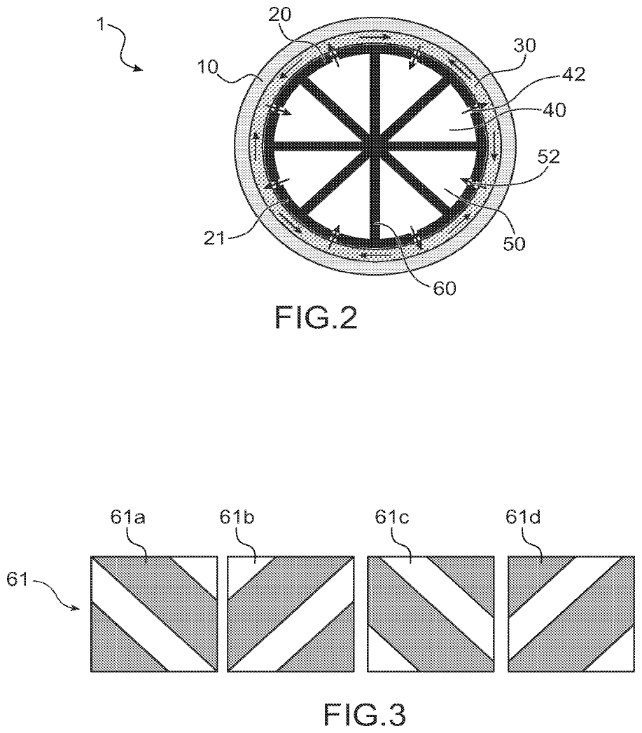

In FIGS. 1 and 2, one exemplary embodiment of a fixed-bed tubular reactor according to a first alternative of the present invention can be seen.

The tubular reactor 1 according to the present invention comprises a hollow tube 10 which extends along a longitudinal axis XX′, between a first end 11 and a second end 12.

The hollow tube 10 may have a symmetry of revolution about the longitudinal axis XX′. The hollow tube 10 may comprise a metal, especially a metal chosen from: steel, alloy of aluminium, of copper, of nickel, among others. The diameter of the inner surface of the hollow tube 10 can be between 5 mm and 100 mm.

The wall, referred to as the first wall, forming the hollow tube 10 can have a thickness of between 0.5 mm and 10 mm. The hollow tube 10 can be between 10 and 200 times its internal diameter.

The tubular reactor 1 also comprises a hollow insert 20 which also extends along the longitudinal axis XX′ and is cylindrical in shape. The hollow insert 20 may be a single-piece part.

The hollow insert 20 is especially housed in the volume V of the hollow tube 10 coaxially therewith. In particular, the insert 20 comprises a wall, referred to as the second wall 21, which defines an annular space 30 with the first wall of the hollow tube.

In this respect, the annular space 30 is filled with a catalyst powder which will be the site of the conversion reactions of reactive gases likely to transit through the tubular reactor 1.

The annular space 30 may have a thickness, defined as the distance between the first wall and the second wall, of between 2% and 20% of the internal diameter of the first wall.

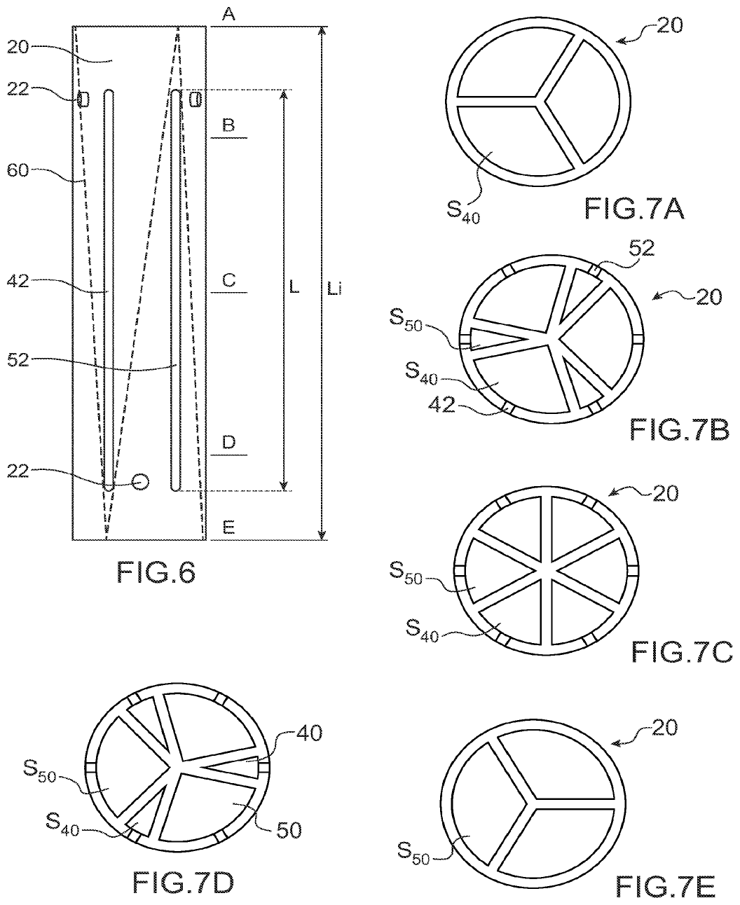

Particularly advantageously, the hollow insert 20 can be provided with centring means holding it in a coaxial position with the hollow tube 10. For example, as represented in FIG. 6 relating to a second alternative of the present invention discussed below, the centring means comprise bosses 22 formed on the second wall 21.

These centring means 22 make it possible to consider especially a hollow insert 20 with a length at least 20 times greater than the diameter of said insert. Furthermore, these centring means 22 also allow the tubular reactor 1 to be more easily mounted.

Moreover, the hollow insert 20 comprises at least one distribution chamber 40 and at least one collection chamber 50. In particular, the hollow insert 20 can comprise between one and four distribution chambers 40, and between one and four collection chambers 50.

The distribution chambers 40 and the collection chambers 50 are advantageously arranged alternately, extend over the entire length of the hollow insert 20 and are separated from each other by partition walls 60.

More particularly, the partition walls 60 extend over the entire length of the hollow insert 20 within the volume defined by the hollow insert 20.

In addition, the at least one distribution chamber 40 comprises an admission opening 41 at one end of the insert 20 through which one or more reactive gases are likely to be admitted.

Equivalently, the at least one collection chamber 50 comprises a discharge opening 51 at the other end of the hollow insert 20 through which one or more gases are likely to be discharged.

The hollow insert 20 is also provided with at least one distribution, or distributing, opening 42 and at least one collection, or collecting, opening 52. In particular, the distribution opening 42 forms a passage that is permeable to reactive gases from the distribution chamber 40 to the annular space 30. Equivalently, the collection opening 52 forms a passage which is permeable to gases from the annular space 30 to the collection chamber 50. In accordance with the invention, and as better illustrated in FIGS. 14 to 16, the hollow insert 20 includes at least one offset distribution opening 42 and one offset collection opening 52.

The distribution opening 42 and collection opening 52 extend over a length L. Advantageously, the length L is greater than half, advantageously three quarters, of the length of extension along the longitudinal axis XX′ of the annular space 30.

In addition, the at least one distribution chamber 40 is sealed at the second end 12, while the at least one collection chamber 50 is sealed at the first end 11. In this respect, as illustrated in FIG. 1, the distribution chamber 40 is sealed by a distribution wall 43, whereas the collection chamber 50 is sealed by a collection wall 53.

Complementarily, the tubular reactor 1 may comprise at the first end 11 and at the second end 12, respectively, a distributing space 13 and a collecting space 14 between which the hollow insert 20 is disposed.

Advantageously, the collection opening 42 and the distribution opening 52 have a width of between 1/100 and ½, advantageously between 1/20 and ¼, of the diameter of the hollow tube 10.

Still advantageously, the collection opening 52 and the distribution opening 42 each comprise a filter 61 preventing passage of catalyst powder into either the collection chamber 50 or the distribution chamber 40.

For example, and as illustrated in FIG. 3, the filter 61 may comprise a plurality of planes 61a, 61b, 61c and 61d comprising fibres. The example illustrated in FIG. 3 comprises four planes, each with rectangular or round fibres tilted by more or less 45° to the longitudinal axis XX′. More particularly, the fibres of two successive planes are oriented at two different angles, and are in particular perpendicular from one plane to another.

Thus, during operation of the reactor 1, one or more reactive gases are admitted into the distribution chamber 40 through the admission opening 41. These gases then pass through the distribution opening 42 and flow into the annular space 30 to come into contact with the bed of catalyst powder. During this flow in the annular space 30, which essentially occurs between a distribution opening 42 and a collection opening 52 immediately adjacent thereto, the reactive gases are at least partly converted into products. These products, as well as the fraction of unreacted reactive gases, pass through the collection opening 52 thus considered and are collected in the collection chamber 50. The products and unreacted gases thus collected are then discharged through the discharge opening 51.

Thus, the extent of the distribution openings 42 over the length L enables the reactive gases to be distributed in the annular space 30 over said length L. In other words, this arrangement enables the quantity of heat likely to be produced during the conversion of the reactive gases into products to be distributed over the entire length L. This arrangement thus enables the local temperature rise of the bed of catalyst powder to be limited. The extent over the length L of the collection openings 52 makes it possible, according to an equivalent principle, to limit heating of the bed of catalyst powder.

In addition, the arrangement of the admission 41 and discharge 51 openings on opposite ends of the hollow insert 20 also contributes to better distribution of the reactants within the annular space 30 and consequently to better homogenisation of the temperature of the bed of catalyst powder.

All these aspects contribute in limiting the occurrence of hot spots and thus preserving the bed of catalyst powder. This results in improved reliability and a longer service life for tubular reactor 1.

According to one particularly advantageous aspect illustrated in FIG. 4, the catalyst powder is retained in the annular space 30 by a seal 31 made of fibrous material at each of the ends of the annular space 30.

Insofar as the seal is made of fibrous material, the latter is necessarily porous and therefore permeable to reactive gases. In this respect, the fibrous material may comprise at least one of the elements selected from: glass fibres, ceramic fibres, metal fibres, carbon fibres, fibres of polymeric material, among others.

In particular, the seal 31 may be in the form of a braid, a sheath, a cord or simply comprise a stuffing of the fibrous material. Advantageously, the fibrous material is a thermal insulator and has a thermal conductivity substantially equivalent to that of the catalyst used (0.2 W/m/K to 10 W/m/K).

According to one advantageous embodiment, the seal 31 made of fibrous material is compressively held against the catalyst powder by a spring 32. For example, the spring 32 is in abutment against a holding plate 33 mechanically connected to the tube 10 via a ring 34.

The seal 31 of fibrous material in combination with the spring or springs 32 helps to compact the catalyst powder and to prevent attrition thereof when the reactor is being handled or transported.

Insofar as the seal 31 is porous, reactive gases can enter the annular space directly without passing through the distribution chamber 40.

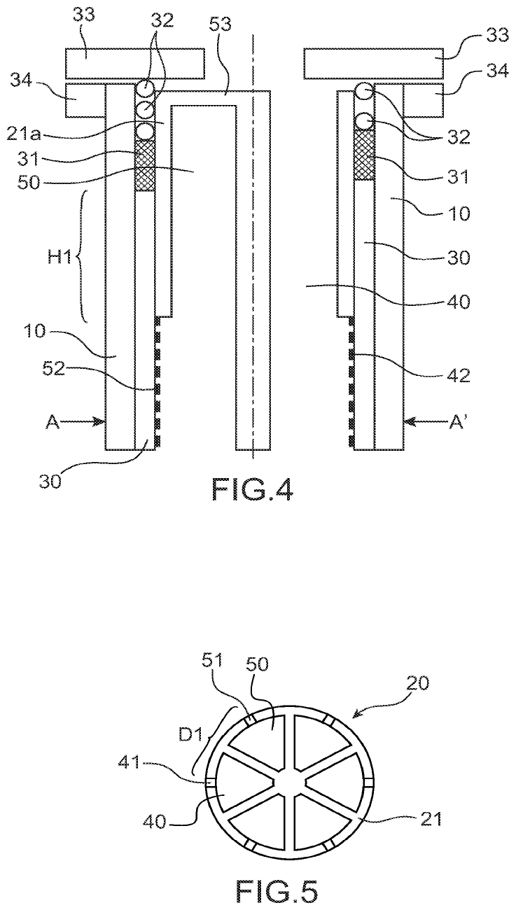

In this case (FIG. 4), it is particularly advantageous to provide an arrangement of the hollow insert 20 enabling this reactive gas to be given a predetermined travel path in the annular space 30 in order to promote its conversion on contact with the bed of catalyst powder. This predetermined path has a length of between 0.2 times and 10 times, advantageously between 1 times and 2 times, the distance D1 (FIG. 5) separating a distribution opening 42 from an immediately adjacent collection opening 52, and measured along the outer surface of the second wall 21 of the insert 20.

To this end, the second wall 21 may be devoid of openings on a first section 21a and a second section which extend from the first end 11 and the second end 12, respectively.

In this respect, the first section 21a and the second section overlap with the bed of powder over a height H1. With the height H1 being between 0.5 times and 10 times, advantageously between once and 2 times, the distance D1 separating a distribution opening 42 from an immediately adjacent collection opening 52, and measured along the outer surface of the second wall 21.

FIG. 6 illustrates a second alternative of the present invention which essentially retains the characteristics of the first alternative. The hollow insert 20 relating to this second alternative is advantageously manufactured using an additive manufacturing technique.

According to this second alternative, the distribution chamber 40 has a convergent profile from the first end 11 to the second end 12.

In other words, the surface area S40 of a cross-section of the distribution chamber 40 along a sectional plane transverse to the longitudinal axis XX′ decreases from the first end 11 towards the second end 12 (FIGS. 7A to 7E), advantageously, the surface area is zero at the second end 12.

Equivalently, the surface area S₅₀ of a cross-section of the collection chamber 50 along a sectional plane transverse to the longitudinal axis XX′ increases from the first end 11 towards the second end 12, advantageously, the surface area is zero at the first end 11.

This arrangement of the distribution chamber 40 and collection chamber 50 minimises head losses associated with gas circulation. Flow rate inhomogeneities in the annular space 30 are thus reduced.

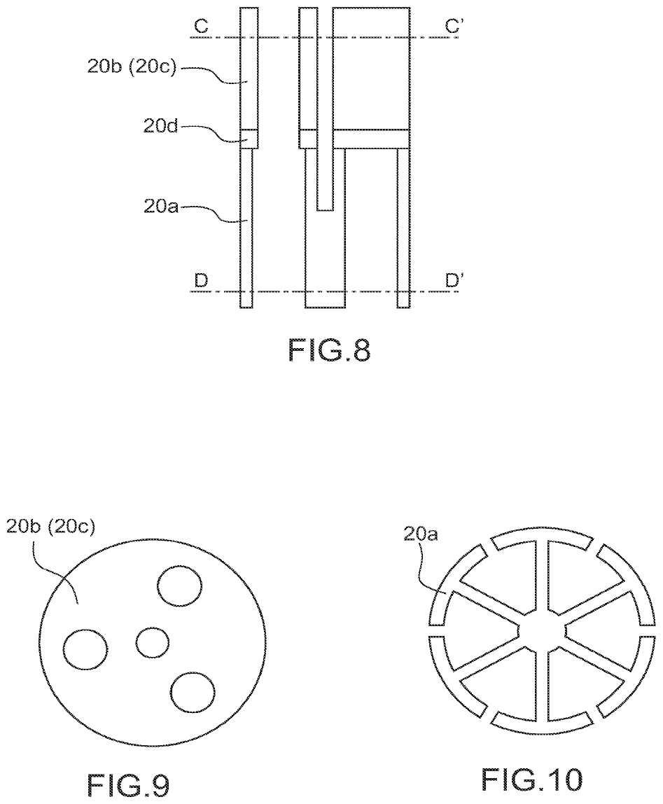

FIG. 8 represents a hollow insert 20 likely to be implemented according to a third alternative of the present invention. This third alternative essentially retains the characteristics relating to the first and second alternatives.

The insert 20 relating to this second alternative can be manufactured by machining, cutting, electrical discharge machining or extrusion, among others.

In particular, according to this alternative, the insert 20 comprises a main body 20a interposed between two end bodies 20b, 20c, and assembled by means of a seal 20d.

The two end bodies 20b, 20c, illustrated in FIG. 8, comprise a non-gas-permeable cylindrical wall reproducing the first section 21a described in the context of the first alternative, and comprise distribution 42 (or collection 52) openings.

As previously indicated, a reactor 1 in accordance with the invention includes an insert 20 provided with at least one offset collection opening 52 and at least one offset distribution opening 42, as explained below.

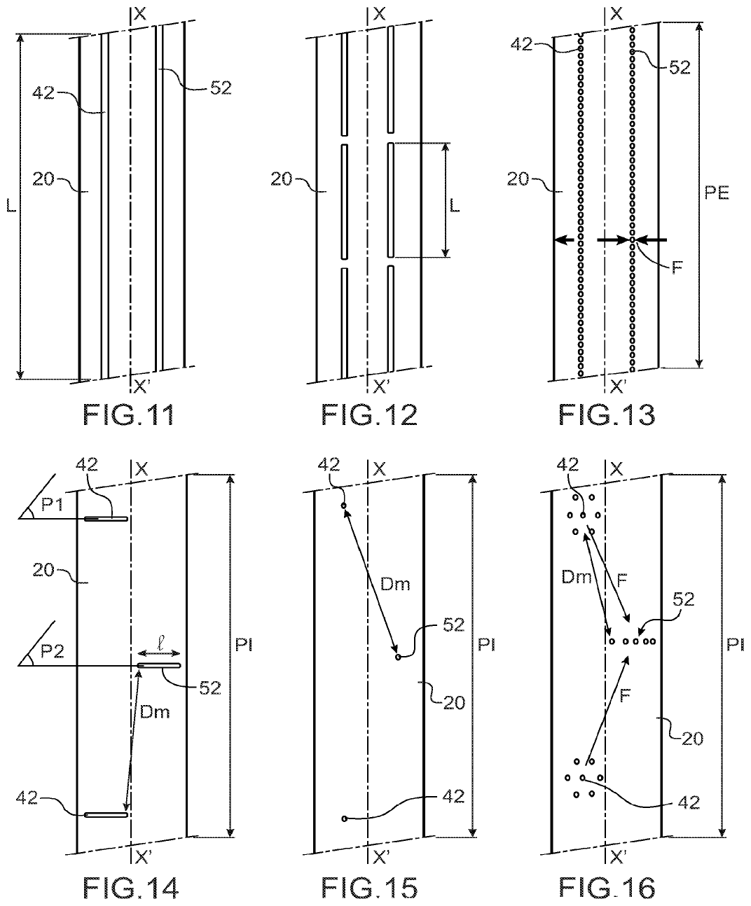

However, as illustrated in particular in FIGS. 11 to 13, the second wall 21 of the hollow insert 20 may include, on one or more second longitudinal portions PE of the insert 20 defined along the longitudinal axis XX′, herein a single second longitudinal portion PE, one or more aligned distribution openings 42 and one or more aligned collection openings 52.

These aligned collection 52 and distribution 42 openings are defined in such a way that any aligned distribution opening 42 is contained in a plane transverse to the longitudinal axis XX′ also containing at least one aligned collection opening 52 so that the direction of flow of gas distributed and/or admitted between an aligned collection opening 52 and an aligned distribution opening 42 has a substantially zero axial component along the longitudinal axis XX′.

Thus, more precisely, as visible in FIGS. 11 to 13, a transverse cross-section of the second longitudinal portion PE of the insert 20 containing an aligned collection opening 52 also contains an aligned distribution opening 42.

In the example of FIG. 11, a single aligned distribution opening 42 having a length L along the longitudinal axis XX′ is provided, as well as a single aligned collection opening 52 also having a length L. These two openings are therefore longitudinally disposed along the axis of the insert 20 continuously. In this case, the insert 20 can especially be made by extrusion, bending or wire cut electrical discharge machining without any subsequent machining.

In the example of FIG. 12, a plurality of aligned collection openings 52 each having a length L and also a plurality of aligned distribution openings 42 each having a length L are provided. The aligned collection openings 52 thus form openings longitudinally disposed along the axis of the insert 20 semi-continuously. The same applies to the aligned distribution openings 42.

In the example of FIG. 13, a plurality of aligned collection openings 52 and a plurality of aligned distribution openings 42 are provided, each in the form of a port, especially of circular, oval, oblong or rectangular shape, for example by using 3D printing. Thus, the openings 42, 52 are disposed at points along the axis of the insert.

In these examples of FIGS. 12 and 13, the openings 42, 52 are machined after manufacturing the insert 20 or else produced by additive manufacturing, especially 3D printing. They provide greater mechanical rigidity and enable a zone without an opening to be maintained at the ends of the insert 20, thereby simplifying catalyst confinement.

In these three configurations, specific to the aligned openings 52, 42 provided in a second longitudinal portion PE of the insert 20, the gas circulation outside the insert 20 takes place in the orthoradial direction, as represented by the arrows F in FIG. 13.

However, in the case where the reaction requires a long residence time of the reactants in the catalyst while maintaining a gas velocity which makes it possible to dispense with limiting phenomena from the kinetic viewpoint, it is advisable to improve the arrangement of such openings 42, 52. Two solutions can especially be contemplated: either the number of sections of the insert 20 can be reduced, with at least two sections; or the openings 42, 52 can organise a circulation which is no longer solely in the orthoradial direction but also incorporates an axial component.

The first solution has a limit, i.e. at least two sections, and it is undesirable to have heat release from only one side of the insert 20, as thermomechanical stresses can occur and deform the tubes. Symmetry can be found with four sections, but this only offers a very small margin.

The second solution is the most appropriate and is the solution implemented by the invention. Specifically, it consists in that the second wall 21 of the hollow insert 20 includes, on at least a first longitudinal portion Pl of the insert 20 defined along the longitudinal axis XX′, at least one offset distribution opening 42 and at least one offset collection opening 52.

These offset openings 52, 42 are defined so that any offset distribution opening 42 is contained in a plane P1 transverse to the longitudinal axis XX′ different from any plane P2 transverse to the longitudinal axis XX′ containing an offset collection opening 52 so that the direction of flow of gas distributed and/or admitted between an offset collection opening 52 and an offset distribution opening 42 has an axial component along the longitudinal axis XX′.

FIGS. 14 to 16 illustrate examples of first longitudinal portions Pl of the insert 20 comprising such offset openings 42, 52.

In the example of FIG. 14, the offset openings 42, 52 are in the form of transverse slots extending over a width/transversely to the longitudinal axis XX′. It is noticed that an offset distribution opening 42 is contained in a transverse plane P1 different from a transverse plane P2 containing an offset collection opening 52.

In the example of FIG. 15, the offset openings 42, 52 are in the form of local ports, especially of circular, oval, oblong or rectangular shape.

In the example of FIG. 16, clouds of offset collection openings 52, for example at least two of which are contained in a same transverse plane, and clouds of offset distribution openings 42, for example at least two of which are contained in a same transverse plane, are formed. In this FIG. 16, the arrows F represent the mixed axial and orthoradial circulation of the flow of gas around the insert 20.

It should be noted that offset openings 52, 42 in the form of longitudinal or transverse slots, as in FIG. 14, or in the form of clouds of ports, as in FIG. 16, make it possible to spread the hot spot resulting from the meeting between the reactive gases and the catalyst over a larger surface area. However, for some reactions which do not exhibit a hot spot, making point injections in the form of local ports, as in FIG. 15, can make manufacture simpler.

In accordance with the invention, the distribution 42 and collection 52 openings are offset and therefore not in a same transverse plane, unlike the aligned openings previously described. Thus, the distance travelled by the gases in contact with the catalyst can be adjusted, and especially this distance can be greater than with a configuration of a second longitudinal portion PE previously described. As a result of this greater distance, the gas circulation rate in the bed of catalyst powder can be adjusted and it is thus possible to improve heat and mass transfers within the bed to obtain a more homogeneous temperature and to improve reaction kinetics.

The layout of the offset distribution openings 42 in the form of clouds of ports or holes, over a wide zone, can be likened to a staging of the reaction to inject a second part of the reagents after reacting a first part of the reagents. In other words, the cloud of offset distribution openings 42 can include at least one offset distribution opening 42 dedicated to a primary gas distribution and at least one offset distribution opening 42 dedicated to a secondary gas distribution, different from the primary gas distribution.

In FIG. 16, there are seven offset distribution openings 42, or injection holes. The central port can, for example, be considered as the primary injection of reagents and the satellite ports, surrounding the central port, can be considered as secondary injections of reagents. The purpose of this double injection is especially to distribute the flow rate and thus the heat of reaction over a larger volume of catalyst and thus limit the temperature level, which is often detrimental to catalyst activity. It may be possible to modify the diameter of these ports to control the share of primary and secondary reagent flow rate. This makes it possible to better manage the heat of reaction, which is often intense when the reactive gas comes into contact with the catalyst. Better management of this heat makes it possible, for example, to maintain performance of the catalyst or maximise selectivity of the reaction.

Furthermore, another advantage of offset openings 42, 52 compared with aligned openings 42, 52 is the possibility of reducing the surface area of the openings between the distribution chambers 40 and the annular space 30. Indeed, a large opening area results in low reagent velocity. This can lead to differential diffusion of species, progressively modifying composition of the reactive mixture axially circulating in the distribution chambers 40. For example, the reactive H₂/CO₂ mixture will be depleted of H₂ as the mixture progresses through the insert 20 because dihydrogen H₂ will diffuse more rapidly through the openings than carbon dioxide CO₂. It is therefore advisable to increase the velocity to promote gas convection at the expense of species diffusion at the distribution openings 42, which involves reducing the number of distribution openings 42, which is made possible by the principle of offset distribution openings 42 as opposed to aligned distribution openings 42.

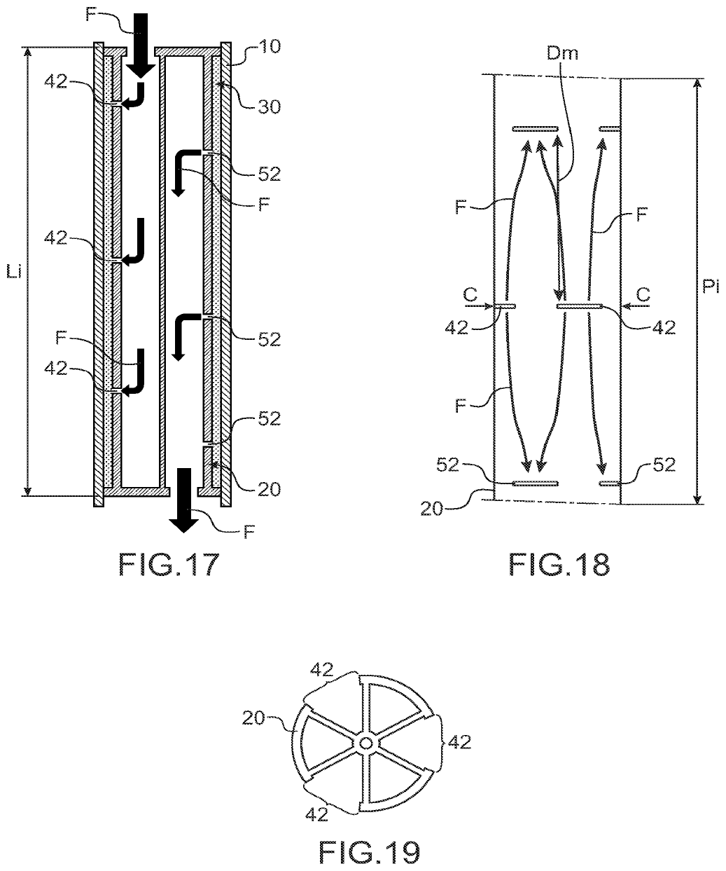

In the example of FIGS. 17 to 19, the axial and orthoradial circulation of the flow of gas F is represented by the arrows F. Running in the axial direction of the insert 20, there is an alternation between the distribution openings 42 and the offset collection openings 52.

It is also noticeable that all the distribution chambers 40, three in this example, are open at the same abscissa or the same cross-sectional plane C-C, as visible in FIG. 19. The same applies to the collection chambers 50.

It is to be noted that the minimum distance Dm between an offset collection opening 52 and an offset distribution opening 42 is between half the diameter of the insert 20 and half the total length L1 of the insert 20, as represented in FIGS. 14, 15, 16 and 18.

The tubular reactor according to the present invention is advantageously implemented for the synthesis of methane, methanol, dimethyl ether or for implementing the Fisher-Tropsch synthesis.

Of course, the invention is not limited to the exemplary embodiments just described. Various modifications may be made thereto by a person skilled in the art.

1. A fixed-bed tubular reactor which extends along a longitudinal axis between a first end and a second end, comprising
a bed of catalyst powder confined in an annular space delimited by a first wall of a hollow tube and a second wall of a hollow insert disposed in the hollow tube and coaxially with the hollow tube,
the hollow insert comprising at least one distribution chamber and at least one collection chamber, separated from each other by a partition wall, and comprising, respectively, a gas admission opening at the first end and a gas discharge opening at the second end, wherein
the second wall comprises at least one distribution opening and at least one collection opening, the distribution opening allowing distribution of a gas likely to be admitted through the admission opening of the distribution chamber into the annular space, and the collection opening allowing collection of the gas distributed into the annular space through the collection chamber, and
the second wall of the hollow insert includes, on at least a first longitudinal portion of the hollow insert defined along the longitudinal axis, at least one offset distribution opening and at least one offset collection opening, any offset distribution opening being contained in a plane transverse to the longitudinal axis different from any plane transverse to the longitudinal axis containing an offset collection opening so that a direction of flow of gas distributed and/or admitted between an offset collection opening and an offset distribution opening has an axial component along the longitudinal axis.

2. The reactor according to claim 1, wherein the second wall of the hollow insert includes, on at least one second longitudinal portion of the insert defined along the longitudinal axis, at least one aligned distribution opening and at least one aligned collection opening, any aligned distribution opening being contained in a plane transverse to the longitudinal axis also containing at least one aligned collection opening so that a direction of flow of gas distributed and/or admitted between an aligned collection opening and an aligned distribution opening has an axial component substantially zero along the longitudinal axis.

3. The reactor according to claim 2, wherein a plurality of aligned collection openings and/or a plurality of aligned distribution openings are axially aligned along the longitudinal axis.

4. The reactor according to claim 1, wherein the at least one collection opening and/or the at least one distribution opening are selected from: a longitudinal slot extending over a length along the longitudinal axis; a transverse slot extending over a width transversely to the longitudinal axis; and a local port, especially of circular, oval, oblong or rectangular shape.

5. The reactor according to claim 1, wherein a plurality of offset collection openings and/or a plurality of offset distribution openings are respectively in a form of a cloud of offset collection openings at least two of which are contained in a same transverse plane and/or in the form of a cloud of offset distribution openings at least two of which are contained in a same transverse plane.

6. The reactor according to claim 5, wherein the cloud of offset collection openings includes at least one offset collection opening dedicated to a primary gas collection and at least one offset collection opening dedicated to a secondary gas collection, different from the primary gas collection, and/or wherein the cloud of offset distribution openings includes at least one offset distribution opening dedicated to a primary gas distribution and at least one offset distribution opening dedicated to a secondary gas distribution, different from the primary gas distribution.

7. The reactor according to claim 1, wherein the at least one offset collection opening and the at least one offset distribution opening are not axially superposed along the longitudinal axis.

8. The reactor according to claim 1, wherein a minimum distance between an offset collection opening and an offset distribution opening is between half a diameter of the insert and half a total length of the hollow insert.

9. The reactor according to claim 1, wherein several offset collection openings are located in a same plane transverse to the longitudinal axis and evenly spaced from each other, and/or wherein several offset distribution openings are located in a same plane transverse to the longitudinal axis (XX′) and evenly spaced from each other.

10. The reactor according to claim 1, wherein the at least one offset collection opening and/or the at least one offset distribution opening are obtained by machining and/or additive manufacturing.

11. The reactor according to claim 4, wherein the local port is of circular, oval, oblong or rectangular shape.
